(19) United States
(12) Patent Application Publication
(10) Pub. No.: US 2009/0269450 A1
(43) Pub. Date: Oct. 29, 2009

(54) Flexible Package Having an Automatic Closure Feature

(75) Inventors: Paul Anthony Zerfas, Verona, WI (US); Jin Zhang Tam, East Lansing, MI (US); Peter Matthew Foltz, Minneapolis, MI (US); Ryon Scott Lockhart, LeRoy, MI (US); Lane Charles Taber, JR., Rancho Santa Margarita, CA (US); Daniel John Little, St. Louis, MI (US); Scott Wesley Wiltz, Milford, MI (US)

Correspondence Address: FITCH EVEN TABIN & FLANNERY, 120 SOUTH LASALLE STREET, SUITE 1600, CHICAGO, IL, 60603-3406, US

(73) Assignee: KRAFT FOODS GLOBAL BRANDS LLC, Northfield, IL (US)

(21) Appl. No.: 12/347,374

(22) Filed: Dec. 31, 2008

Related U.S. Application Data
(60) Provisional application No. 61/047,695, filed on Apr. 24, 2008.

(51) Int. Cl. A23L 1/48; B65B 55/00; B65B 3/02

(52) U.S. Cl. 426/123; 426/410; 53/558

(57) ABSTRACT

A reclosable flexible package is suitable for retail sale of food products and is comprised of a film material. The flexible package includes a pair of semi-rigid strips attached to the walls of the flexible pouch and positioned parallel to the package opening. The semi-rigid strips are configured and arranged to nest together and bias toward one another. Upon opening of the package, the semi-rigid strips are moveable between a closed position and an open position. Further, the semi-rigid strips are configured such that they automatically reclose the package when the strips are released from the open position.

### TECHNICAL FIELD

This invention relates generally to packaging, and more particularly to a disposable food packaging comprising a pouch made of a film material with an automatic closure feature.

### BACKGROUND

Flexible film packages are well known in the art and typically comprise disposable pouches commercially produced on high-speed form-fill-seal machines from rolls of plastic film material. The flexible film packages have cavities within which pluralities of contents, such as food products, are stored. Consumers often consume only a portion of the package's contents. A package reclosability feature allows the user to discharge a portion of the contents through the package opening and then seal the opening to reclose the flexible package.

Numerous reclosable flexible packages are well known in the art. By one approach, reclosable flexible packages have press-to-close zipper closures. Press-to-close zippers require alignment of two profiles located on opposing package walls to interlock the closure and reclose the package. This alignment may be cumbersome and/or time consuming for consumers, especially younger or older consumers who may have limited manual dexterity. In addition, if a particulate food product, like shredded cheese or bread crumbs, is stored within the flexible package, the particulate may interfere with the alignment of the zipper profiles, which often have narrow channels or tracks.

In another approach, the reclosable flexible packages include a slider zipper closure. The slider closures on these flexible packages assist with the alignment of the two profiles located on the package walls; however, these slider closures require additional plastic material and manufacturing that come with additional costs. While the sliders allow the users to more easily align the package wall profiles, the slider closures create a slight opening between the slider and the side seal when the package is in the closed configuration. Further, the zipper slider remains on the slider tracks when the package is in the open position and the slider extends into the opening, thereby slightly reducing the size of the pouch opening.

In addition, typical recloseable flexible packages do not automatically reclose themselves. These reclosable flexible packages typically require affirmative manual action to reclose. Thus, the user must remember to close the package and accurately press-to-seal the closure or pull the zipper slider to the closed configuration between each usage. Further, if one of these reclosable flexible package is in inadvertently dropped, while open, the contents may be permitted to spill out. The consumer must remember or have sufficient time to reclose the package to avoid possible spilling or spoilage of the package contents.

### SUMMARY

The package described herein comprises a flexible pouch made of film material and a pair of semi-rigid strips attached to the walls of the flexible pouch positioned such that the semi-rigid strips align and bias toward one another. Upon removal of the top portion, the semi-rigid strips are moveable between a closed position and an open position. Further, the semi-rigid strips are configured such that they automatically reclose the package when the strips are released from the open position. The strips may extend along the entire width of the flexible pouch or may extend between the side seals of the pouch.

To commercially produce the self-closing flexible package having the semi-rigid strips, high-speed form-fill-seal equipment having a vertical or horizontal configuration may be employed. In one embodiment, cavities are formed out of film material in an in-line operation such that the strips may be added to the inside or outside surfaces of the film material. The semi-rigid strips may be secured to the front and back panels by heat sealing or adhesive bonding.

### BRIEF DESCRIPTION OF THE DRAWINGS

The above needs are at least partially met through provision of the flexible pouch having an automatic closure feature described in the following detailed description, particularly when studied in conjunction with the drawings, wherein:

FIG. 1 comprises a front elevational view of a flexible package as configured in accordance with various embodiments of the invention;

FIG. 2 comprises a cross sectional view of the flexible package of FIG. 1 along line 2-2;

FIG. 3 comprises an isometric cross sectional view of the flexible package of FIG. 1 in the open configuration;

FIG. 4 comprises a cross sectional view of the flexible package of FIG. 1 in the open configuration;

FIG. 5 comprises a perspective view of the flexible package of FIG. 1 in the open configuration;

FIG. 6 comprises a front elevational view of another embodiment of a flexible package;

FIG. 7 comprises a cross sectional view of the flexible package of FIG. 6 along line 7-7;

FIG. 8 comprises a rear elevational view of another embodiment of a flexible package;

FIG. 9 comprises a cross sectional view of the flexible package of FIG. 8 along line 9-9;

FIG. 10 comprises a cross sectional view of another embodiment of a flexible package;

FIG. 11 comprises a perspective view of the flexible package of FIG. 10 in the open configuration;

FIG. 12 comprises a partial perspective view illustrating an apparatus as configured in accordance with an embodiment of the invention;

FIG. 13A comprises a partial perspective view illustrating an apparatus configured in accordance with an embodiment of the invention;

FIG. 13B comprises a partial perspective view illustrating an apparatus as configured in accordance with an embodiment of the invention;

FIG. 14 comprises a partial perspective view illustrating an apparatus as configured in accordance with an embodiment of the invention;

FIG. 15 comprises a perspective view of a of another embodiment of a flexible package;

FIG. 16 comprises a cross sectional view of the flexible package of FIG. 15;

FIG. 17 comprises a perspective view of the flexible package of FIG. 15 in the open configuration;

FIG. 18 comprises a perspective view of another embodiment of a flexible package;

FIG. 19 comprises a cross sectional view of the flexible package of FIG. 18.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

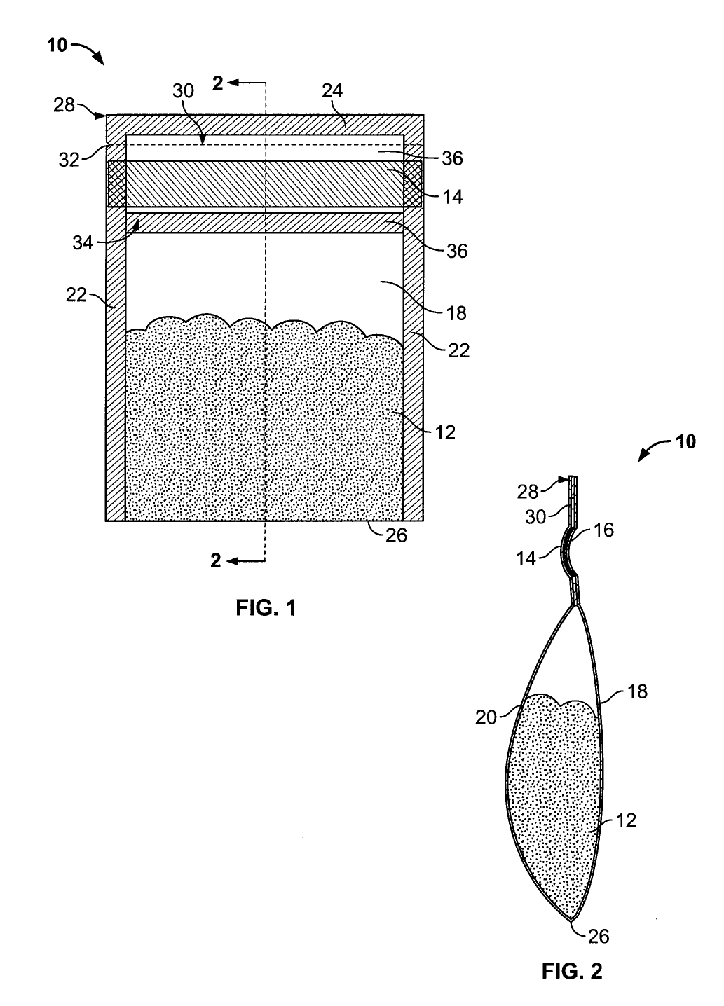

Generally speaking, pursuant to these various embodiments, a flexible package or pouch with an automatic closure feature is illustrated in FIGS. 1-11. The flexible pouch 10, as shown in FIGS. 1-5, may be used for packaging food products 12, such as particulate food products including shredded cheese, cereal, and trail mix, to note but a few. The flexible pouch 10 has a pair of curved semi-rigid strips 14, 16 that run parallel to the pouch opening. The curved, semi-rigid strips 14, 16 are configured and arranged to nest together and bias toward one another. The first and second semi-rigid strips 14, 16 are secured to the opposed front and back panels 18, 20 of the flexible pouch 10 and the biasing of the strips 14, 16 biases the panels 18, 20 to the closed configuration. The flexible pouch 10 may be comprised of a flexible film material that is formed using high-speed form-fill-seal equipment. The flexible pouch may have a variety of seals, folds, and other features as determined by a variety of considerations, such as the products stored in the pouch and the method of manufacturing the pouch, to note but a few.

In one illustrative embodiment, as depicted in FIG. 1, the flexible pouch 10 includes front and back panels 18, 20 that have a side seals 22, a top seal 24, and a bottom fold 26. To facilitate access to the product, the flexible pouch 10 includes a removable top portion 28. A distance below the removable top portion 28, the front and back panels 18, 20 have curved semi-rigid strips 14, 16 located thereon. Upon removal of the top portion, the curved semi-rigid strips 14, 16 are movable between an open position permitting dispensing of the food product and a closed position that limits or prevents egress of the food product.

As shown in FIG. 1, the side seals 22 extend along the outside edges of the panels 18, 20 to create the pouch 10. The side seals 22, top seal 24 and similar seals discussed herein may be conventional heat-seals. Such conventional heat seals may be created by reciprocating heat sealing bars or other suitable sealing apparatus and are well known to those skilled in the art.

In addition, the flexible pouch 10 includes an area of weakness 30 that assist the user with separating the removable top portion 28 from the flexible pouch 10. The area of weakness 30 may be a mechanical or laser score line. This line may be linear or non-linear. If the area of weakness is non-linear, the flange at the top of the package (discussed below) may not extend entirely across the package width. In addition to a laser score line, the area of weakness 30 may include perforations. The score line or perforations may be extended along the entire width of the flexible pouch 10. Instead, or in addition to a score line, the area of weakness 30 may include a tear initiation feature 32 along only a portion of the pouch, such as, for example, a small V-notch or slit on one edge of the package. For example, as shown in FIG. 1, the area of weakness 30 may include a tear initiation feature 32 aligned with a score line.

Where the flexible pouch 10 is used for food products 12, a hermetic seal 34 is desirable to ensure product freshness. The hermetic seal 34 may have a pealably openable characteristic. In the illustrative embodiment of FIG. 1, the pealable hermetic seal 34 is positioned below the curved semi-rigid strips 14, 16. In another embodiment, the hermetic seal 34 may be created by the top seal 24 if the area of weakness 30 takes the form of a score line as opposed to perforations, which would interfere with the hermetic seal 34 created by the top seal 24. In addition, the flexible pouch 10 may have a tamper evidence feature.

Below the area of weakness 30, the front and back panels 18, 20 each have a curved semi-rigid strip 14, 16 secured thereon. The curved semi-rigid strips 14, 16 have a slight arc and are positioned on the panels 18, 20 such that the curved strips nest tightly together. More particularly, the curvature of the first curved semi-rigid strip 14 aligns in the same direction as the curvature of the second curved semi-rigid strip 16 as illustrated in FIG. 2. The radius of curvature of the curved semi-rigid strips 14, 16 may be larger or smaller than that illustrated in FIG. 2.

The curved semi-rigid strips 14, 16 may have a variety of dimensions. For example, the strips 14, 16 may have a radius of curvature from 0.125 to 6.0 inches, a thickness of 0.007 to 0.050 inches, a height of 0.125 to 2.5 inches, and a length of 0.75 to 20 inches. In one illustrative embodiment, the curved semi-rigid strips 14, 16 are about 1.25 inches in height, 5.75 inches in length, with a radius of curvature of 1.25 inches, and a thickness of about 0.015 inches. Depending on the dimensions and features of the flexible pouch 10, the curved semi-rigid strips 14, 16 may extend the entire width of the package, as shown in FIG. 1, or may extend in between the side seals 22 such that the strips 14, 16 terminate at the inside margin of the side seal 22. Other embodiments are contemplated, such as, for example, an embodiment having curved semi-rigid strips 14, 16 that terminate in the middle of the side seals 22.

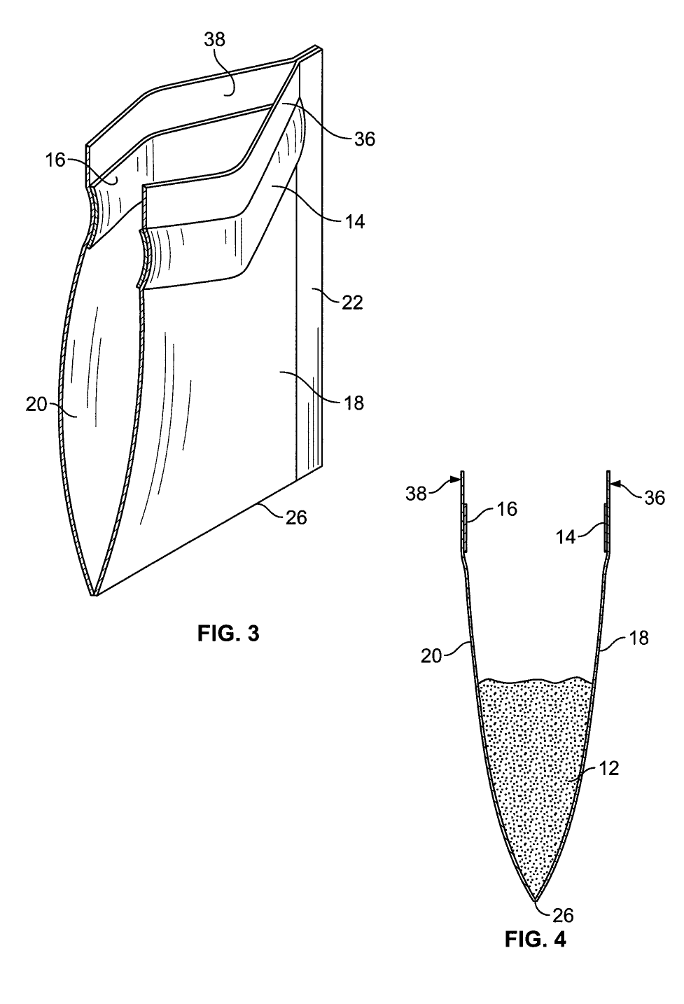

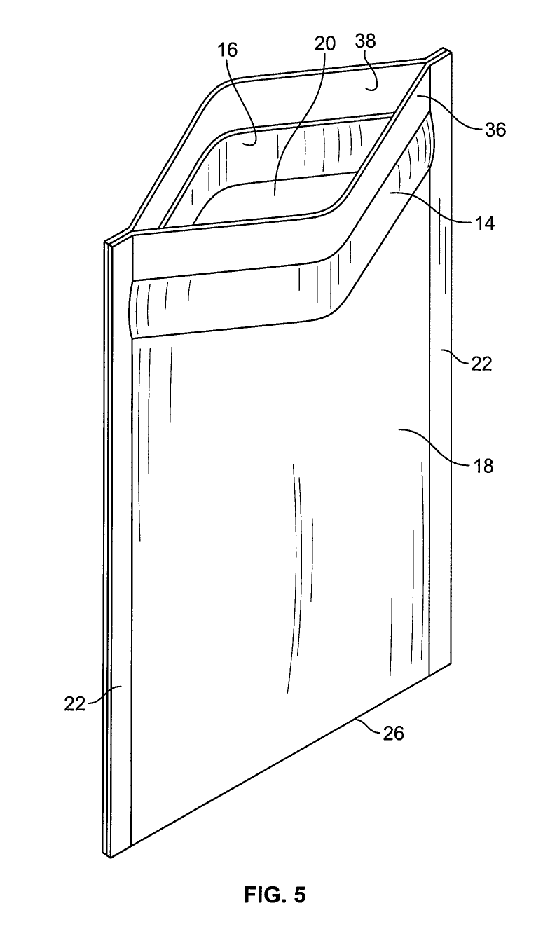

As suggested, the curved semi-rigid strips 14, 16 bias toward one another to automatically close the flexible pouch 10 upon release from the open position. The curved semi-rigid strips 14, 16 are in their stable resting configuration when they are extended to their full length. When the curved semi-rigid strips 14, 16 are separated and moved to a fully open position, as shown in FIGS. 3 and 4, lengthwise tension is induced in the strips 14, 16 such that when the strips are released from that position, they automatically move to the fully extended position which brings the strips 14, 16 together tightly and closes the flexible pouch 10. Further, in addition to the curved semi-rigid strips 14, 16 imparting an automatic closure feature to the flexible pouch 10, the strips 14, 16 create an audible snap when the flexible package recloses. The audible snap assures the consumer that the package is securely closed and the unused portion of the contents will remain fresh.

As shown in FIG. 1, the curved semi-rigid strips 14, 16 are positioned parallel to the opening created at the top of the pouch 10 upon the removal of the top portion 28. In addition, the curved semi-rigid strips 14, 16 are positioned a distance form the area of weakness 30. In one embodiment, the strips 14, 16 are positioned about 0.75 inches from the top film edge. This distance may vary and a desired distance may be between 0.125 and 2.0 inches.

The curved semi-rigid strips 14, 16 may be comprised of a variety of materials including a relatively heat resistant polymer such as polyethylene terephthalate (PET), high impact polystyrene (HIPS), polypropylene (PP), high density polyethylene (HDPE), another of a variety of relatively stiff polymers, or a thin strip of resilient metal such as a thin strip of steel. The curved semi-rigid strips 14, 16 may be secured to the panels 18, 20 in a variety of manners such as, for example, by heat sealing or adhesive bonding. Further, the strips 14, 16 may be attached to the inside or outside surfaces of the panels 18, 20. By one approach, the first and second curved semi rigid strips 14, 16 have an external heat seal layer compatible with a sealant on the respective front and back panels 18, 20.

The semi-rigid spring-loaded strips 14, 16 may be produced in a variety of manners such as by stamping, injection molding, thermoforming, extrusion, or by a combination of two or more of these processes. For example, the strips may be stretched and rapidly quenched after profile extrusion. In addition, the curved semi-rigid strips 14, 16 may be produced either as separate elements, pairs, or as a continuous ribbon of strip material wound onto a reel. In one embodiment, the curved semi-rigid strips 14, 16 may be brought to the line in pre-cut strips. In another manufacturing process, the curved semi-rigid strips 14, 16 may be formed in-line. For example, in one embodiment, the material from which the curved semi-rigid strips 14, 16 is formed is wound on a reel in a flat form such that the curvature of the semi-rigid strips 14, 16 is imparted by a forming process such as a thermoforming tool when the material is unwound from the reel.

Turning now to FIGS. 3 and 5, the flexible pouch 10 is illustrated in the open configuration. Above the curved semi-rigid strips 14, 16 and below the area of weakness 30, a portion of film material extends, which comprises the panel flanges 36, 38. Thus, when the removable portion 28 has been separated from the flexible pouch 10, the panel flanges 36, 38 extend above the curved semi-rigid strips 14, 16 and may be grasped by the user. In one illustrative embodiment, the strips 14, 16 are positioned between 0.5 and 1.0 inches from the top edge of the film material. Thus, in one illustrative embodiment, the panel flanges 36, 38 may be between 0.25 and 0.8 inches in height. Such panel flanges 36, 38 provide loose film for easy grasping, which assists with the opening of the pouch 10.

To open the flexible pouch 10, the user may manually grasp and pull the front and back panel flanges 36, 38 apart from one another. Pulling the panel flanges 36, 38 with a mild force causes the package to move to a fully open configuration. Once opened, the flexible pouch 10 may be held in the fully open configuration by applying longitudinal compression to the sides of the flexible pouch 10 where the curved semi-rigid strips 14, 16 terminate. Continuous application of such longitudinal compression retains the flexible pouch 10 in the fully open configuration, as shown in FIGS. 3-5. The fully open configuration allows significant access to the food products stored within the flexible pouch 10. In one embodiment the flexible package is sized to allow one-hand manual application of the longitudinal compression.

Upon release of the longitudinal compression, the spring-tension of the curved semi-rigid strips 14, 16 causes them to snap back to the closed position thereby automatically closing pouch 10. As mentioned, the closing action may be rapid and accompanied by an audible snap sound. After returning to the closed position, the matching curvature of the curved semi-rigid strips 14, 16 is forced tightly together creating a secure closure at the top of the flexible pouch 10.

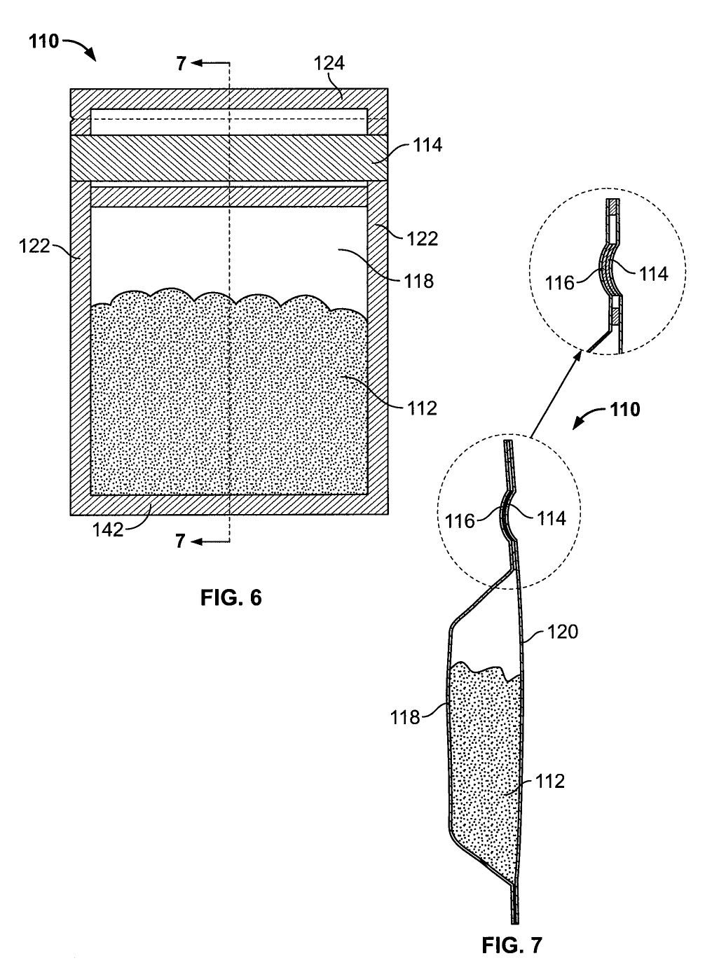

Turning now to FIGS. 6 and 7, there is illustrate another embodiment of a flexible pouch. In this and subsequent embodiments, similar flexible pouches are illustrated having slightly different features. For convenience, features of the various embodiments that correspond to features already discussed with respect to previously discussed embodiments are identified using the same reference numeral in combination with a prefix (such as ‘1’) to distinguish the different embodiment. For example, flexible pouch 110 corresponds to previously described flexible pouch 10.

As shown in FIG. 6, flexible pouch 110 includes side seals 122, a top seal 124 and a bottom seal 142. This embodiment may be produced out of two rolls of film material that are heat sealed together. In this example, the curved semi-rigid strips 114, 116 extend to the outside edges of the side seals 122. As shown in FIG. 7, the flexible pouch 100 comprises a front panel 120 that is generally vertical and a back panel 118 within which a bulge is created to accommodate a plurality of food product 112.

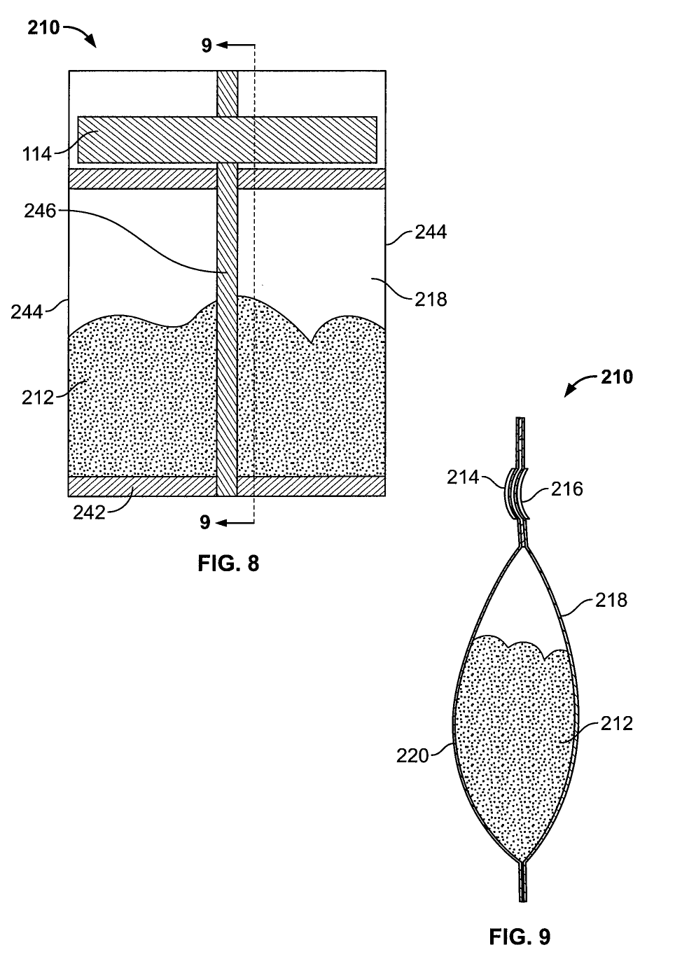

Turning now to FIGS. 8 and 9, there is illustrated another embodiment of a flexible pouch 210. The flexible pouch 210 includes a bottom seal 242, side folds 244, and a lap or fin seal 246 along the back of the flexible pouch 210. The fin seal 246, like side seals 22, may be conventional heat seals. As shown in the illustrative embodiment of FIG. 9, the curved semi-rigid strips 214, 216 are secured to the outside surfaces of the front and back panels 218, 220.

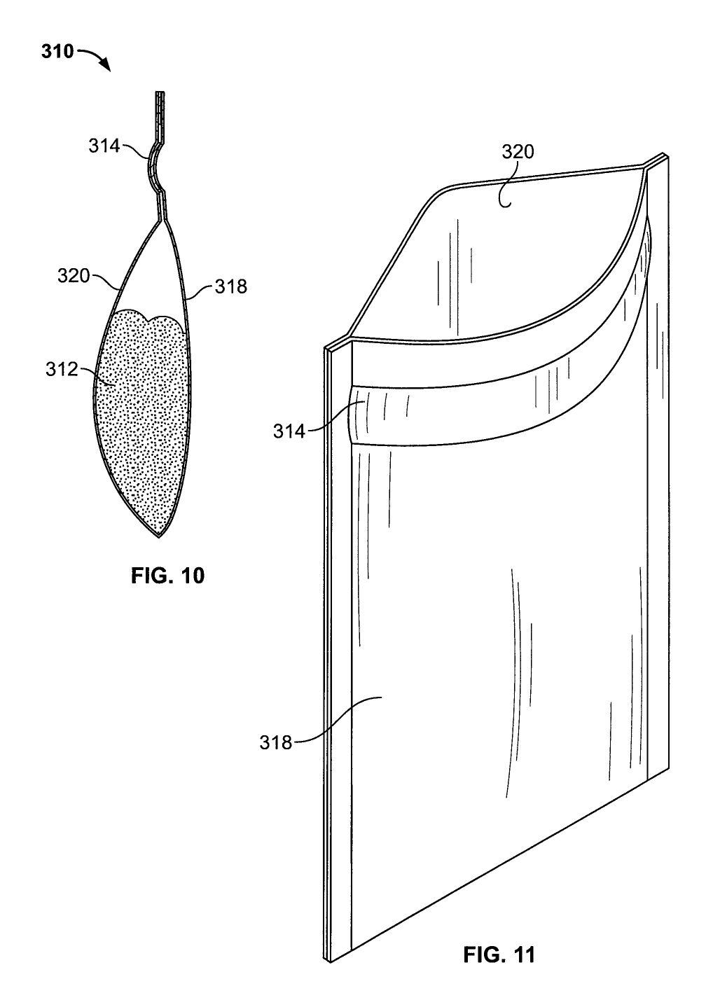

In yet another illustrative embodiment, depicted in FIGS. 10 and 11, a flexible pouch 310 is illustrated. The flexible pouch 310 is similar to the flexible pouch 10 described above except that flexible pouch 310 has only one curved semi-rigid strip 314 secured to one of either the front or back panels 318, 320. Such an embodiment functions similarly to the previously discussed embodiments, except that the closure may not be as air-tight as the previous embodiments but the flexible pouch 310 uses less strip material and thus has a cost savings.

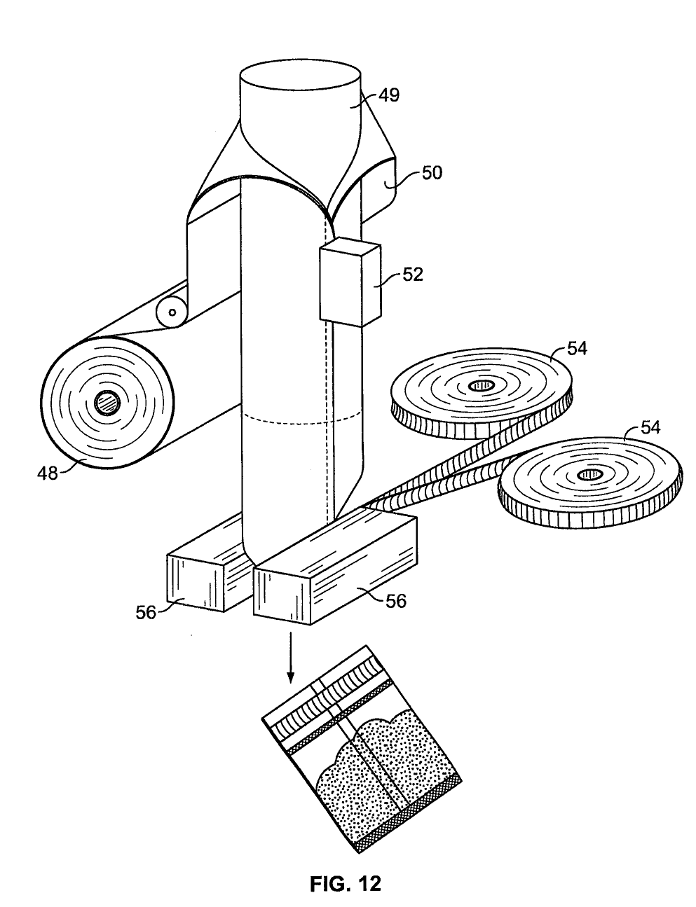

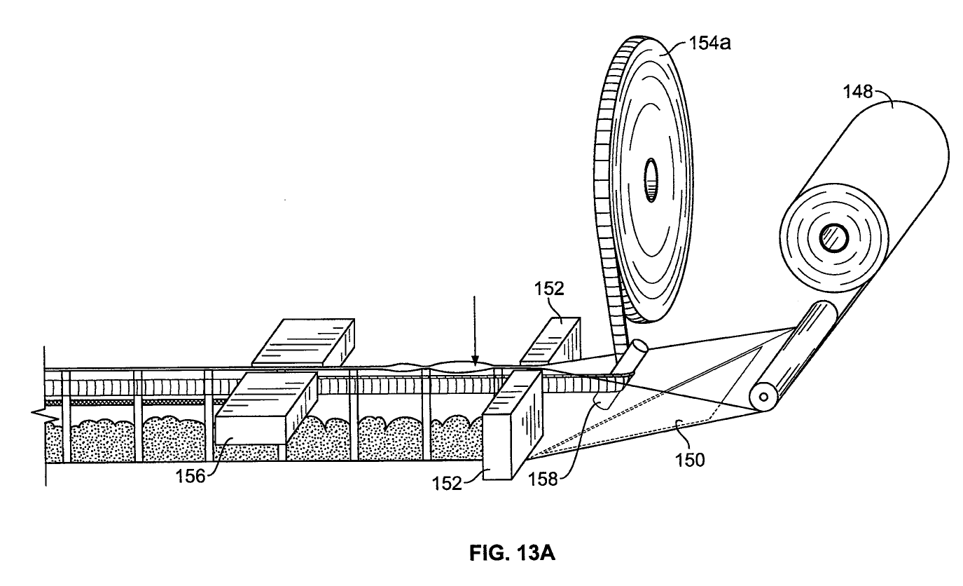

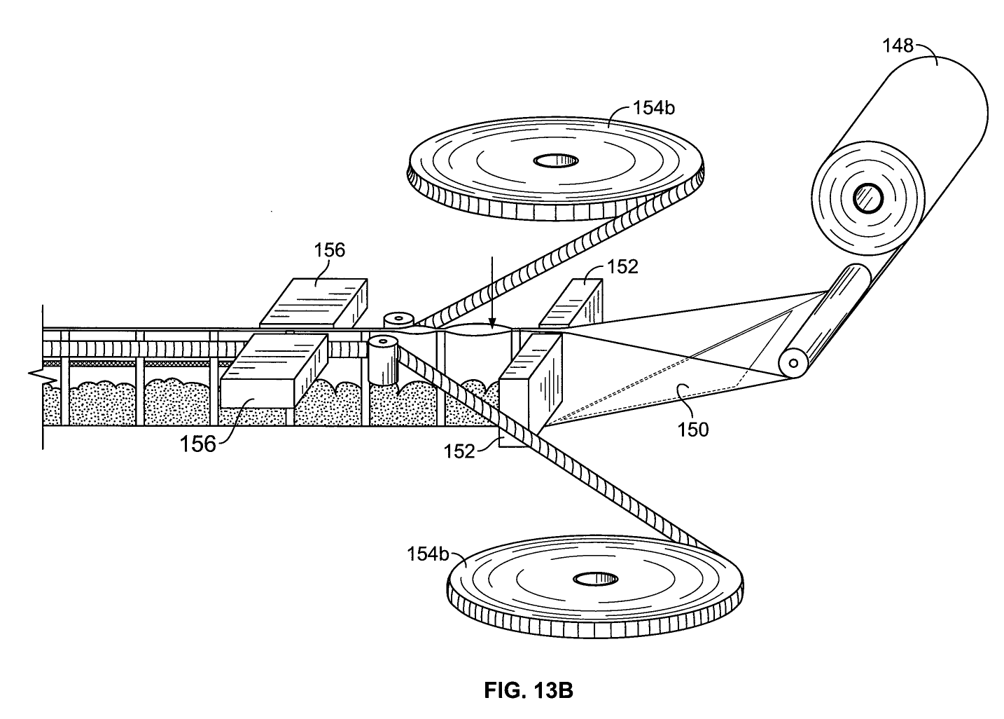

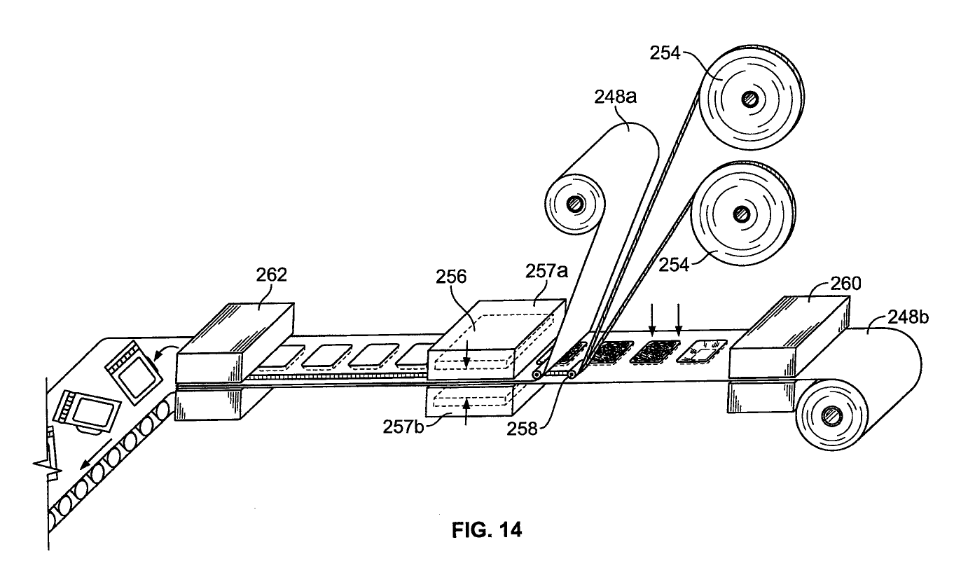

As mentioned above, the method of manufacturing the flexible pouches may affect the particular seals, folds, and various other features of particular flexible pouches. A variety of manufacturing methods are available to commercially produce the flexible pouches and a few examples will be discussed herein and illustrated in FIGS. 12-14. The flexible pouches may be made in a high-speed form-fill-seal (FFS) operation that produces up to 800 packages per minute. The FFS operation may be on a vertical FFS machines as illustrated in FIG. 12 or also may be on a horizontal FFS machine as illustrated in FIGS. 13A and 13B or on a horizontal thermoform-fill-seal (HTFFS) machine as shown in FIG. 14. The curved semi-rigid strips may also be secured to the pouches in a variety manners, such as by heat sealing or adhesive bonding via an add-on equipment module designed to work in harmony with the pouch-making machines of the FFS operation.

In one illustrative embodiment shown in FIG. 12, the flexible pouches are made in a vertical FFS or bagging line. A series of flexible pouches is formed from a roll of film 48, such that the front and back panels of the film material define a cavity. By one approach, a web of the rolled film material is fed over a folding shoulder 50 such as a forming collar and mandrel to provide it with a tubular shape. Opposite longitudinal edges of the film are brought together around the fill tube 49. The longitudinal edges are sealed, such as by a seal tool 52 to form a fin seal, or overlapped to form a lap seal. In one illustrative embodiment, the curved semi-rigid strips are wound on reels 54. The strips are brought into alignment with a reciprocating seal tool 56 for attachment to the walls of the flexible pouch. A bottom seal for the pouch is also formed by the reciprocating sealing tool 56, which may include a pair of reciprocating sealing bars. The reciprocating sealing bars are heat sealing bars maintained at a desired temperature to apply heat and pressure to the front and rear walls. Further, the heat seal bars are brought together on opposite sides of the tubular web so that heat is conductively transferred to the film from both sides while pressure is applied. The sealing bars may be used in an intermittent or continuous operation. In an intermittent operation, the film is stopped while the sealing bars engage the film. In a continuous operation, the sealing bars may move vertically at the machine speed as they engage the film. During operation, sealing tool 56 attaches the curved semi-rigid strips and creates a top seal in a lower pouch and creates a bottom seal in an upper pouch at roughly the same time. In addition, sealing tool 56 may contain a reciprocating knife which acts to separate the bottom pouch from the upper pouch. Once the operation is complete and the upper pouch has been filled with food product, the upper pouch advances downward and becomes the bottom pouch to which curved semi-rigid strips are attached. In addition to attaching the strips and sealing the pouches, the sealing tool 56 may also be used to impart the curvature to the curved semi-rigid strips and/or to create the area of weakness. By one approach, the sealing tool 56 has a cutting device associated therewith to create a perforation across the top of the package or a notch at the edge of the package to aid in tear initiation. By another approach, the area of weakness in the pouch is not perforated at the package line but is pre-scored (mechanically or with a laser) at the film manufacturer.

As mentioned, the strips are attached to flexible pouches such that the curvature of the first curved semi-rigid strip aligns with the curvature of the second curved semi-rigid strip. The strips may be attached to the vertical FFS pouch in a variety of manners, e.g., hot melt adhesive, pressure sensitive adhesive, and heat sealing, to note but a few options. As mentioned above, the curved semi-rigid strips may be applied to the outside surfaces of the walls. In one vertical FFS process, the curved semi-rigid strips have an external heal seal layer compatible with a sealant on the outside surface of the package walls. In one such vertical FFS operation, the curved semi-rigid strips are secured to the front and back panels in a direction perpendicular to the machine direction on the outside surface of the panels.

After a bottom seal is formed in the flexible pouch, the partially formed flexible pouch is then filled with food product, which is introduced into the pouch via the fill tube 49. In one embodiment, an area of weakness is formed in the flexible pouches to define a removable top portion. By one approach, a notch, score line, or other feature to facilitate removal of the top portion of the package may then be formed near the top of the pouch. A hermetic seal may also be created in the disposable pouch. The sealing tool 56 may perform a variety of functions simultaneously, including: creating the bottom seal of the pouch that is about to be filled with product; attaching the semi-rigid strips to the upper portion of the front and back panels and creating a peelable heat seal just below the strips on the pouch that was just filled; and having a reciprocating knife or cutting tool which separates the pouch that was just filled from the following one which is about to be filled. The reciprocating cutting tool may also create an area of weakness such as a perforation across the top of the package or a notch at the package edge. By another approach, the area of weakness in the pouch is not perforated at the package line but is pre-scored (mechanically or with a laser) at the film manufacturer such that the scored area of weakness is built into the film as it arrives from the manufacturer. If such an approach is taken, the film should be positioned on the packaging machine via optical registration so that the previously imparted score line is in the correct position when the flexible pouch is formed.

There are a variety of alternative steps to those described in this vertical FFS operation. Also, high speed techniques may be employed instead of application of heat and pressure by heat seal bars as described above. For example, RF energy, ultrasonic energy or other techniques may be employed.

In another example, shown in FIG. 13A, flexible pouches are manufactured in a horizontal FFS or a flow-form wrapper. Like the vertical process described above, a series of flexible pouches is formed and the film material defines a cavity having front and back panels. FIG. 13A illustrates a single roll of film 148 being folded at a folding apparatus 150 and then sealed with a sealing die 152 to form pouch cavities in series with one another. After the film is formed into cavities, the cavities are filled with food product. The strip-alignment roller 158 is set at an angle to cause the strips to turn after unwinding and to be redirected so that they are aligned in the proper orientation for attachment to the flexible pouches. As shown in FIG. 13A, a double roll of strips 154a is located on the reel. As the strips are positioned and sealed to the pouches and the pouches are advanced in the machine direction, the strips are continuously unwound from the roll 154a and advanced in the machine direction along with the pouches. As the double layer of continuous strips 154a is unwound, the strips are dispensed from the roll and positioned between the two front and back panels of the film material. In this embodiment, the strips are sealed to the inside surface of the front and back panels. As shown in FIG. 13A, the seal bars 156 seal the flexible pouch and strips from both sides of the pouch. By one approach, having the strips on the inside of the pouch material makes the sealing process easier because the sealing bars 156 are configured to transfer heat through the pouch material, which is thinner than the semi-rigid strips. Whereas, the strips may be of a thicker material and thus, may require more, heat, pressure, or time, to be affected by the heat seal process. The sealing bars 156 may also create an area of weakness in the package such as by a cutting device associated therewith. By another approach, a separate mechanical or laser score tool (not shown) may be employed in-line to create the score line in the formed packages. By yet another approach, the area of weakness such as the score line is already formed in the film when the film arrives from the manufacturer.

In another embodiment such as that shown in FIG. 13B, the flexible pouches are made in a horizontal FFS or a flow-wrapper line similar to the example shown in FIG. 13A. A series of flexible pouches is formed from a single roll of film 148 that is folded at a folding apparatus 150, such as a folding plow as shown in FIG. 13B, and then sealed with a sealing die 152 to form pouch cavities in series with one another. After the film is formed into cavities, the cavities are filled with food product. In the illustrative embodiment of FIG. 13B, the horizontal FFS process has two separate reels 154b with curved semi-rigid strips, instead of the single roll of double layer strips 154a shown in FIG. 13A. A continuous ribbon of curved semi-rigid material is dispensed to the line from the reel and then secured to the pouch cavities at sealing die 156. It is also contemplated that pre-cut strips may be brought in-line and secured to the flexible film pouches. The sealing die 156 also imparts a top seal to the flexible pouch and may also create a peelable seal, if desired. The filled cavities are then separated from one another, such as by a reciprocating knife, not shown.

In yet another embodiment, illustrated in FIG. 14, the flexible pouches are made on horizontal thermoform-fill-seal equipment (TFFS). As shown, such a process may employ two rolls of film material 248a, 248b. A series of product cavities are thermoformed from a flexible plastic bottom film 248b, which can then be filled with a food product. The forming of the bottom film 248b occurs at thermoforming station 260. After the lower cavities are filled with a product, the curved semi-rigid strips are introduced at the proper position between the top and bottom films. The strips may arrive to the in-line process pre-cut or on a continuous reel of semi-rigid spring strip material that may or may not require further forming processing. In the illustrative embodiment of FIG. 14, the curved semi-rigid strips are positioned on two reels 254, mated together with one another at strip roller guide 258, and brought in series to be attached to the flexible pouch.

After alignment of the curved semi-rigid strips and the top and bottom films, the films and the semi-rigid strips enter a sealing station 256. This sealing station 256 is generally contained within a vacuum chamber, especially when the food product requires low oxygen vacuum packaging or modified atmosphere packaging. Within the sealing station 256 are an upper moveable heated seal bar 257a and an unheated moveable lower seal support die 257b, which act together to apply heat and pressure to the upper and/or lower films, accomplishing all of the necessary heat seals to define the final package (such as the package shown in FIGS. 6 and 7) including the side seals, the top and bottom seals, the peelable seal below the semi-rigid strips, as well as sealing the curved semi-rigid strips to the top and bottom films.

Upon leaving the sealing station 256, the formed flexible pouches move in series to a trim station 262 where the pouches are separated from one another. The trim station 262 may also create the area of weakness in the pouches such as by a cutting device. Alternatively, a separate mechanical or laser score tool (not shown) may be employed in-line to create the score line in the film as it is unwound from the roll, prior to forming the packages. By another approach, the area of weakness is already formed in the film when the film arrives from the manufacturer. However, if pre-scored film is employed it should be registered on the packaging machine so that the scored line is in the correct position once the pouches have been formed.

By one horizontal TFFS process, the strips are sealed between the top film 248a and the bottom film 248b such that they are attached to the inside surfaces of the bottom film and the top film. More particularly, the film may have a heat sealable layer on the inside surface which seals to the resin material of the semi-rigid strips. In yet another embodiment, the strips have an external heat seal layer compatible with a sealant on the inside surface of the film.

The film material or substrate of the flexible pouch may be formed as a polymeric sheet of various plastic polymers, copolymers, co-extrusions and/or laminations. Further, the film material may be a monolayer polymeric film or a multilayer laminate comprising an outer layer of durable material and one or more inner barrier layers and sealant layers. The multilayer combination may be comprised of polyolefin such as polyethylene (high, medium, low, linear low, and/or ultra low density polymers including metallocene), polypropylene (non-oriented, oriented, and/or biaxially oriented); polybutylene; ethylene vinyl acetate (EVA); polyamides (non-oriented, oriented, and/or biaxially oriented) such as nylon; polyethylene terephthalate (non-oriented, oriented, and/or biaxially oriented); polyvinyl chloride; ethylene vinyl alcohol (EVOH); polyvinylidene chloride (PVDC); polyvinyl alcohol (PVOH); polystyrene; or combinations thereof. In addition, adhesive tie layers may also be used.

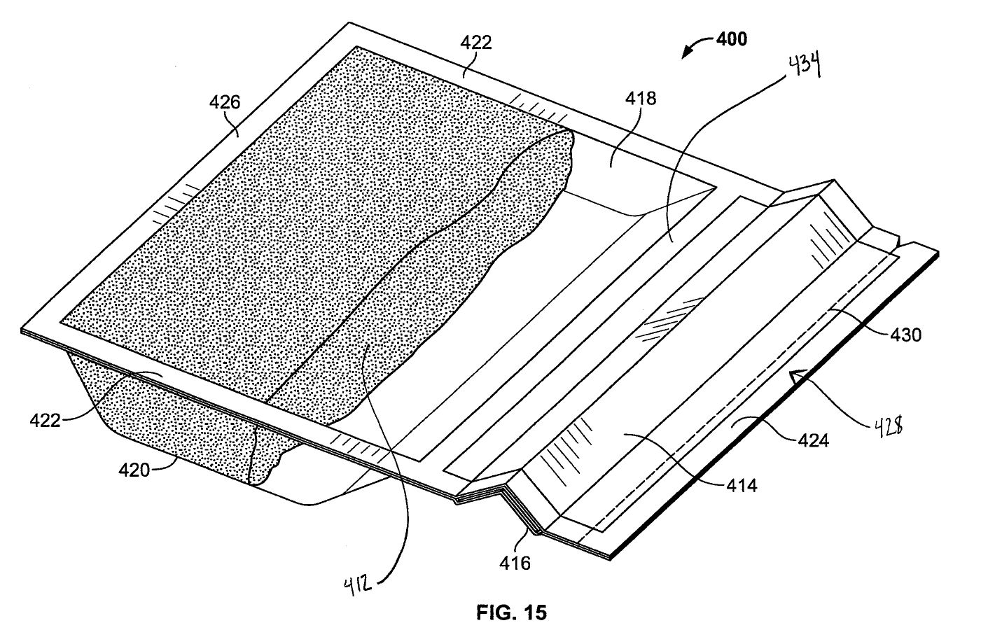

In addition to the curved, semi-rigid strips 14, 16 described above, it is also contemplated that the semi-rigid strips may have alternative cross-sectional configurations. For example, an illustrative embodiment in FIG. 15 includes a flexible package 400 having a pair of semi-rigid strips 414, 416 with a slight fold therein such that the strips have a crease, angle, or v-shape imparted thereto. The partially folded semi-rigid strips 414, 416 extend nearly the entire width of the package and are parallel to the pouch opening. The partially folded, semi-rigid strips 414, 416, like previous strips, have matching profiles and are configured to automatically close the package 400 once the partially folded, semi-rigid strips 414, 416 are released from an open position. More particularly, once released from the open position, the strips and associated panels 418, 420 are forced tightly together creating a secure closure at the top of the flexible pouch 400.

As with curved, semi-rigid strips 14, 16, the partially-folded semi-rigid strips 414, 416 are configured and arranged to nest together and bias toward one another. The first and second partially-folded, semi-rigid strips 414, 416 are secured to the opposed front and back panels 418, 420 of the flexible pouch 400 such that the profiles of the strips align in the same direction. Further, the biasing of the strips 414, 416 biases the panels 418, 420 to the closed configuration. The pouch 400 may be comprised of a thin, flexible film material such as that formed using high-speed form-fill-seal equipment previously discussed. While the package 400 includes a side seal 422, a top seal 424, and a bottom seal 426, a variety of seals, folds, and other pouch features are contemplated for use with the partially-folded, semi-rigid strips 414, 416.

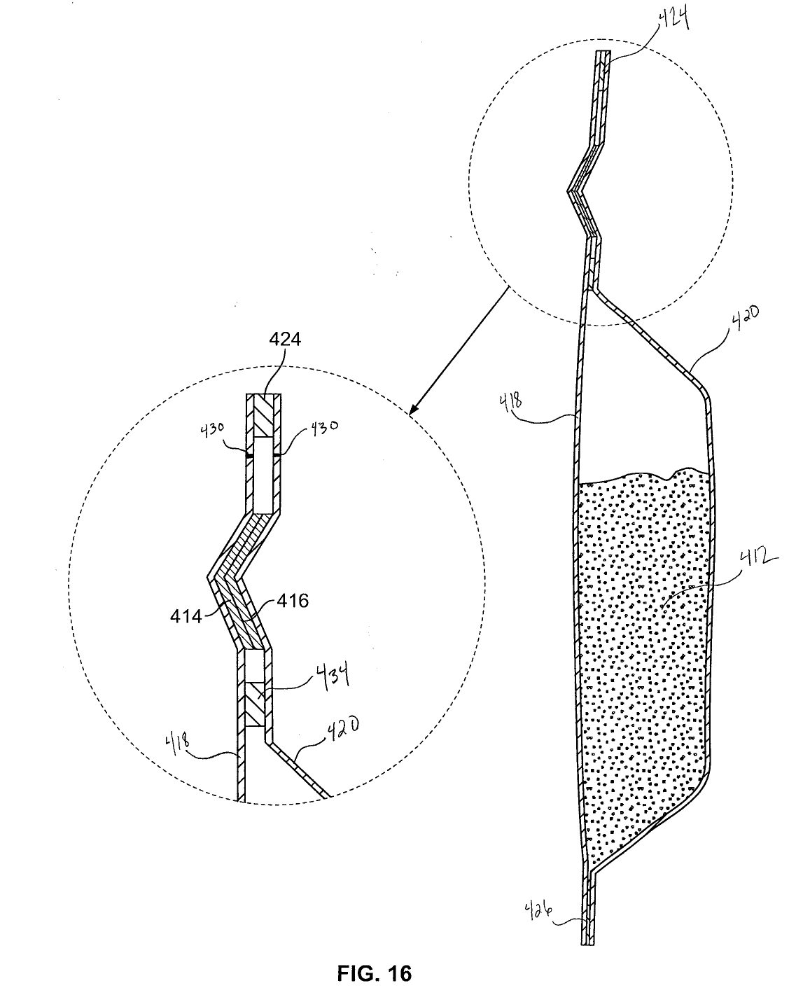

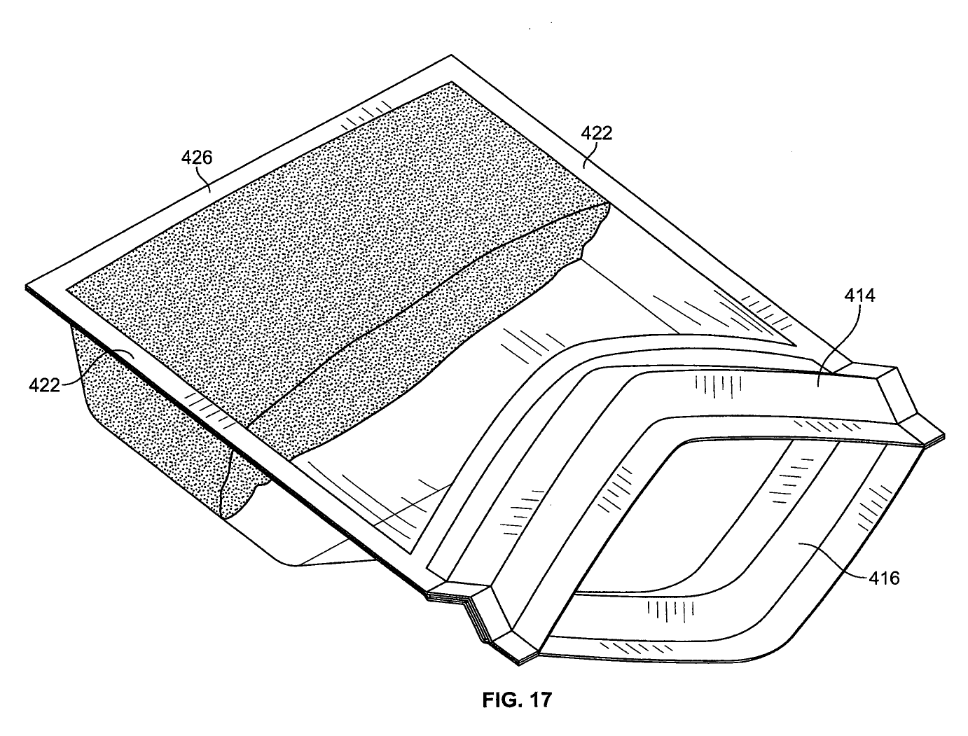

The pouch 400, illustrated in FIG. 15, includes an area of weakness 430 that facilitates removal of the top portion 428. The area of weakness 430, by one approach, is positioned a distance below the top seal 424 and a distance above the partially-folded, semi-rigid strips 414, 416 such that a portion of the front and back panels 418, 420 comprises a flange 436, 438 that can be manually grasped and separated to open the package 400 once the top portion 428 has been removed. While flexible pouch 400 illustrates the partially-folded, semi-rigid strips 414, 416 attached to inside surfaces of the front and back panels 418, 420, as shown in FIG. 16, it is also contemplated that the strips 414, 416 may be affixed to outside surfaces. To ensure freshness of the food product 412, the flexible pouch 10 may include a hermetic seal. By one approach, the hermetic seal may include the top seal 424. By another approach, the hermetic seal may include a pealable hermetic seal 434.

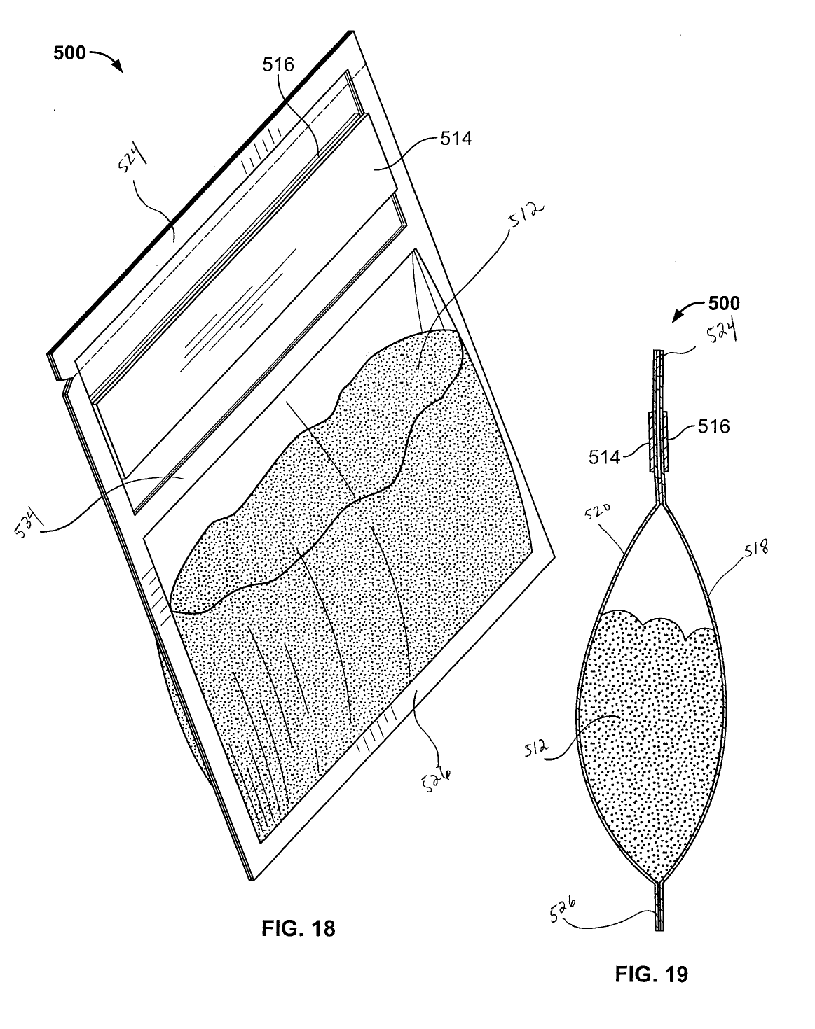

Another illustrative flexible pouch 500, shown in FIGS. 18 and 19, includes planar semi-rigid strips 514, 516. By one approach, the planar semi-rigid strips 514, 516 extend nearly the entire width of the package and are parallel to the pouch opening. As with previous strips, planar semi-rigid strips 514, 516 bias toward one another such that the pouch automatically closes when the strips 514, 516 and associated panels 518, 520 are forced tightly together. The planar semi-rigid strips 514, 516 have a flat profile and are secured to the front and back panels 518, 520 such that the strips 514, 516 generally overlap. Thus, like previous strips, planar strips 514, 516 nest together by overlapping or having significant surface to surface contact. Additional configurations for the semi-rigid strips are contemplated. Further, the flexible pouch may have a variety of configurations with differing seals, folds, and various other features.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A packaged food product suitable for commercial mass production comprising:
a flexible pouch having a front panel and a back panel made of film material;
a food product disposed within the flexible pouch;
said flexible pouch comprising:
first and second semi-rigid strips, the first semi-rigid strip attached to the front panel and the second semi-rigid strip attached to the back panel;
front and back panel flanges positioned above the first and second semi-rigid strips;
wherein the first and second semi-rigid strips are configured and arranged to bias toward one another; and
wherein upon opening of the packaged food product, the first and second semi-rigid strips are movable between an open position permitting dispensing of said food product and a closed position that limits or prevents egress of said food product.

2. The packaged food product of claim 1 further comprising a removable top portion and an area of weakness that facilitates removal of the top portion.

3. The packaged food product of claim 2 wherein the first and second semi-rigid strips are configured and arranged to nest together, significantly overlapping the first and second semi-rigid strips.

4. The packaged food product of claim 3 wherein the first and second semi-rigid strips have a length, height and profile, wherein the length of the first and second semi-rigid strips is positioned parallel to the removable top portion.

5. The packaged food product of claim 4 wherein profile of the first semi-rigid strip is aligned in the same direction as the profile of the second semi-rigid strip such that the first and second semi-rigid strips significantly overlap one another in the closed position.

6. The packaged food product of claim 4 wherein the first and second semi-rigid strips are positioned a distance below the area of weakness on the front and back panels thereby creating the front and back panel flanges.

7. The packaged food product of claim 4 wherein the first and second semi-rigid strips are spring strips configured and arranged to remain in the open position upon continuous application of a longitudinal compression.

8. The packaged food product 7 wherein the flexible pouch can be moved from the closed position to the open position by manually pulling the front and back panel flanges apart from one another, and wherein the flexible pouch can be maintained in open position by one-handed application of inward force to the ends of said strips.

9. The packaged food product of claim 4 wherein the flexible pouch automatically recloses when the first and second semi-rigid strips are released from the open position.

10. The packaged food product of claim 4 wherein the length of the first and second semi-rigid strips extends along an opening of the flexible pouch between side seals of the flexible pouch.

11. The packaged food product of claim 4 wherein the length of the first and second semi-rigid strips extends along an entire width of the flexible pouch.

12. The packaged food product of claim 11 wherein the width of the flexible pouch is sized to facilitate one-handed manipulation of the flexible pouch by applying manual pressure where the first and second semi-rigid strips meet outer edges of the flexible pouch.

13. The packaged food product of claim 1 further comprising a tamper evidence feature.

14. The packaged food product of claim 1 further comprising a hermetic seal.

15. The packaged food product of claim 14 wherein the hermetic seal comprises a non-reclosable peelable seal positioned parallel and below the first and second semi-rigid strips.

16. The packaged food product of claim 14 wherein the hermetic seal is provided via a perimeter heat seal joining upper ends of the front and the back panels and the packaged food product further comprises an area of weakness that comprises a score line.

17. The packaged food product of claim 1 wherein the food product comprises a plurality of separate food products.

18. The packaged food product of claim 1 wherein the flexible pouch is capable of being formed in-line with a form-fill-seal machine.

19. The packaged food product of claim 1 wherein the first and second semi-rigid strips are comprised of at least one of a heat resistant polymer and resilient steel.

20. The packaged food product of claim 19 wherein the first and second semi-rigid strips are comprised of at least one of polyethylene terephthalate (PET), high impact polystyrene (HIPS), polypropylene (PP), and high density polyethylene (HDPE).

21. The packaged food product of claim 1 wherein the first and second semi-rigid strips have a profile, wherein the profile is one of the following:
curved;
angled; and
planar.

22. A method of mass producing a packaged food product in high-speed form-fill-seal equipment comprising:
forming a series of disposable pouches having front and back panels made of film material, each of the disposable pouches defining a cavity therein;
filling the cavity of the disposable pouches with a food product;
hermetically sealing the disposable pouches;
attaching a first semi-rigid strip to the front panel and a second semi-rigid strip to the back panel with each of the semi-rigid strips having a profile aligned with the profile of the adjacent semi-rigid strip such that the strips align, the first and second semi-rigid strips being biased toward one another; and
separating the disposable pouches from one another.

23. The method of claim 22 further comprising forming a removable top portion in the disposable pouches defined by an area of weakness.

24. The method of claim 22 wherein the first and second semi-rigid strips are attached to inside surfaces of the front and the back panels.

25. The method of claim 22 wherein the first and second semi-rigid strips are attached to outside surfaces of the front and back panels.

26. The method of claim 22 wherein the first and second semi-rigid strips are pre-cut.

27. The method of claim 22 wherein strip material from which the first and second semi-rigid strips are produced dispensed from a reel.

28. The method of claim 27 wherein the strip material is wound on the reel in flat form such that the profile of the first and second semi-rigid strips is imparted by a thermal forming tool when the material is unwound from the reel.

29. The method of claim 22 wherein attaching the first and second semi-rigid strips comprises at least one of:
heat sealing the first and second semi-rigid strips to the inside surface of the front and back panels;
heat sealing the first and second semi-rigid strips to the outside surface of the front and back panels;
adhesive bonding the first and second semi-rigid strips to the inside surface of the front and back panels;
adhesive bonding the first and second semi-rigid strips to the outside surface of the front and back panels.

30. The method of claim 29 wherein heat sealing the first and second semi-rigid strips comprises having an external heat seal layer compatible on the first and second semi-rigid strips that is compatible with a sealant on the front and back panels.

31. The method of claim 22 wherein the first and second semi-rigid strips are attached in an orientation parallel to the machine direction.

32. The method of claim 22 wherein the first and second semi-rigid strips are attached in an orientation perpendicular to the machine direction via a strip applicator module configured and arranged to cut and heat-seal the first and second semi-rigid strips to the disposable pouch.

33. A method for mass producing a packaged food product in a horizontal thermoform-fill-seal equipment comprising:
thermoforming a series product cavities from a thermoformable flexible plastic bottom film;
filling the thermoformed series of product cavities;
securing the first semi-rigid strip to the bottom film;
securing the second semi-rigid strip to a flexible top film;
heat sealing the flexible top film to the bottom film, the films defining a pouch wherein the first and second semi-rigid strips significantly overlap one another and the first and second semi-rigid strips have profiles that align in the same direction such that the strips nest together in a closed position.

34. The method of claim 33 wherein securing the first semi-rigid strip to the bottom film comprises heat sealing.

35. The method of claim 33 wherein securing the first semi-rigid strip to the bottom film comprises adhesive bonding.

36. The method of claim 33 wherein the first and second semi-rigid strips are attached to inside surfaces of the front and the back panels.

37. The method of claim 33 wherein the first and second semi-rigid strips are attached to outside surfaces of the front and the back panels.

38. The method of claim 33 wherein the first and second semi-rigid strips are pre-cut.

39. The method of claim 33 wherein strip material from which the first and second semi-rigid strips are dispensed from wound on a reel.

40. The method of claim 39 wherein the strip material is wound on the reel in flat form such that the profile of the first and second semi-rigid strips is imparted by a thermal forming tool when the material is unwound from the reel.

41. The method of claim 33 wherein the first and second semi-rigid strips are attached in an orientation parallel to the machine direction.

42. The method of claim 33 wherein the first and second semi-rigid strips are attached in an orientation perpendicular to the machine direction via a strip applicator module configured and arranged to cut and heat-seal the first and second semi-rigid strips to the disposable pouch.

43. An apparatus for mass producing a packaged food product in high-speed form-fill-seal equipment comprising:
means for forming series of disposable pouches comprising front and back panels made of film material, each of the front and back panels having an inside surface and an exterior surface and a removable top portion defined by an area of weakness;
means for filling the disposable pouches with a food product;
means for hermetically sealing the pouches;
means for attaching to a first semi-rigid strip to the front panel and a second semi-rigid strip to the back panel, such that upon removal of the top portion, the first and second semi-rigid strips of the disposable pouch are movable between an open position and a closed position; and
wherein the first and second semi-rigid strips are configured and arranged to nest together and bias toward one another such that upon release of the semi-rigid strips from the open position, the disposable pouch automatically snaps to the closed position.

44. A packaged food product suitable for commercial mass production comprising:
a flexible pouch having a front and a back panel made of film material;
a food product disposed within the flexible pouch;
said flexible pouch comprising:
a removable top portion;
an area of weakness to facilitate removal of the top portion; and
a spring strip being attached to either the front or the back panel below the area of weakness;
a panel flange positioned between the spring strip and the area of weakness; and
wherein upon removal of the removable top portion, the spring strip is movable between an open pouch position permitting dispensing of said food product and a closed pouch position that limits or prevents egress of said food product, wherein the flexible pouch automatically closes when the spring strip is released from the open pouch position.

45. A packaged product suitable for commercial mass production comprising:
a flexible pouch having a front panel and a back panel made of film material;
a product disposed within the flexible pouch;
said flexible pouch comprising:
a removable top portion;
first and second semi-rigid strips, the first semi-rigid strip attached to the front panel and the second semi-rigid strip attached to the back panel;
front and back panel flanges positioned between the removable top portion and the first and second semi-rigid strips;
wherein the first and second semi-rigid strips are configured and arranged to nest together and bias toward one another; and
wherein upon removal of the removable top portion, the first and second semi-rigid strips are movable between an open position permitting dispensing of said product and a closed position that limits or prevents egress of said product.
